(19) United States
(12) Patent Application Publication
(10) Pub. No.: US 2010/0036522 A1
(43) Pub. Date: Feb. 11, 2010

(54) AIRPORT BAGGAGE CONVEYOR SYSTEM

(76) Inventor: Jochen Stich, Nurnberg (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/922,118

(22) PCT Filed: May 12, 2006
(86) PCT No.: PCT/EP2006/062271

§ 371 Date: Oct. 23, 2009

(30) Foreign Application Priority Data
Jun. 15, 2005 (DE) 10 2005 027 687.3

(51) Int. Cl. B65G 43/08; G06F 7/00; G06F 19/00; B65G 43/10

(52) U.S. Cl. 700/226

(57) ABSTRACT

The invention relates to a conveyor system comprising an electronic control which provides a plurality of local material flow controls and a material flow monitoring system. The local material flow controls are associated with respective individual branch points in the conveyor system and calculate for every item conveyed, upon its arrival in the area of the branch point, the conveyor path towards the respective desired destination while taking into consideration possible disturbances of individual conveyor sections. The local material flow controls are provided with information on possible disturbances via a corresponding transmitting facility of the material flow monitoring system in the fashion of radio messages broadcast across the conveyor system.

The invention relates to a conveyor system, especially an airport baggage conveyor system according to the preamble of claim 1.

Airport baggage conveyor installations as special conveyor systems are known, for example, from DE 199 31 576 A1. Here, the baggage items are transported along transport sections containing a plurality of branch points to respectively preset destinations. The transportation is here controlled by means of a main control system, which ensures that the baggage items reach the respective destination on transport routes. The transport route presets are implemented by means of a subordinate control system, which knows neither the destination nor the preset route. If a baggage item, therefore, comes to a branch, then the subordinate control system enquires from the main control system, quoting the identification number of the baggage item, the direction in which the baggage item is to be forwarded. The subordinate control system then ensures that the baggage item is respectively transported in the directed preset by the main control system. At each branch point, it is necessary to ask once again for the associated direction. In large conveyor systems, this leads to a very high data volume, which has to be centrally handled, and possibly to poor response time characteristics of the main control system.

In addition, a conveyor system is known in which the subordinate control system only knows the transport routes to the respectively next-situated intermediate destinations. Consequently, an enquiry to the main control system is here made whenever an intermediate destination is reached. The routes which are necessary in order to get from intermediate destination to intermediate destination are therefore already implemented in the subordinate control system; they can have be transferred, for example, from the main control system to the subordinate control system.

It is also known to assign to the branch points switch tables, which have direction information for each baggage item.

In particular, from DE 2028836 A1, a pneumatic tube conveyor installation having a central multiple switch can be derived, in which the transport containers are transported in tubes of a tube system having branch points. The transport containers carry identity flags, which, at the point of dispatch, can be stored as coded information in central switching units. The identity flags are registered upon arrival by scanning elements assigned to the central switching units; the destination information is received by the central switching unit following the retrieval of a memory address corresponding to the identity flag. The switching units then control the switches at the branch points on the basis of the destination information assigned to each identity flag. The direction in which a transport container is forwarded is thus realized at a higher level on the basis of a transport route assigned to the identity flag. A master control system here intervenes in the transportation of the container, to be precise through the determination of the destination on the basis of the identity flag and, derived from the destination, by presetting of the forwarding direction at the branch point to be passed, in dependence on the planned transport route. In this conveyor system also, the central control system has to handle a high data volume.

Furthermore, from DE 411 62 83 A1, a transport system for the transportation of conveyed items via calculated transport paths is known. The conveyed items are here constituted by sewing products, which are to be transported to a desired work station (destination). The conveyed item undergoes distribution by a multiplicity of distributing devices, which are interconnected by transport rails. Each of the distribution devices is controlled by an electronic control circuit, which is connected to a host computer for the overall control of the transport system. The host computer generates the destination signals for each of the conveyed items in order respectively to transport this item onwards. The control circuits store the destination commands for this, transmitted from the host computer, in a destination command table. To ensure correct assignment, the conveyed items are provided with identification numbers, which can be read by means of numerical reading devices. The transport system consists of a plurality of transport lines, which are interconnected by bridging rails. In the event of a disturbance, for example in the form of a jam, the host computer arranges a diversion, in that the conveyed items are conducted via another transport line. Through such controlling of the distribution devices, the conveyed item reaches its destination even when there is a disturbance present on a transport path. Here too, the host computer directly performs the control in the form of destination presets, which is likewise associated with the drawback of a high data volume.

Finally, from EP 1 510 479 A1, a conveyor system for, in particular, airport baggage is known, in which a master control system, for each conveyed product, inputs a destination into a destination table and presets the transport route in the form of switch tables. Subordinate control systems receive the destination table, containing the respective destinations of the individual conveyed items, and switch tables, in which, for each destination, the forwarding direction is recorded at a branch point of the conveyor system, and thereby execute the destination control. In this system, a separation of destination information and route information is obtained, which separation is advantageous with regard to the data volume to be handled. The full set of switch tables defines the individual transport routes. In case of disturbances, the master control system revises the switch tables such that the disrupted conveyor portions are by-passed. To enable the routing to be properly effected, the subordinate control systems in the region of the branch points must boast a sensor system by which the identity of the individual conveyed items can be identified so as to determine the destination from the destination table which is to be aimed for and then to be able to read the forwarding direction from the switch table.

The object of the invention is to provide a conveyor system according to the preamble of patent claim 1 and having an electronic control system, in which the data volume to be centrally handled is as low as possible, combined with a high level of fail-safeness.

This object is achieved according to the invention, in a conveyor system of the generic type, by virtue of the characterizing features of patent claim 1. Advantageous refinements of the invention emerge from the subclaims.

The basic concept of the present invention lies in conducting the control of the individual parts of the conveyor system, i.e. especially of the individual conveyor portions and of the branch points fully decentrally and in providing just a blanket device for observing the operating state of the individual parts of the conveyor system and in supplying the decentralized control systems with abnormalities in the sense of generally available messages (distributed in the manner of a radio transmission), so that they can be taken into consideration by the decentralized control systems in the transport route planning and the implementation thereof.

To this end, the invention provides that the electronic control system of the conveyor system has a material flow monitor and a multiplicity of local material flow control systems. The material flow monitor boasts a sensor system for registering the operating state of the conveyor portions and branch points, which can be of any chosen type (for example switches, corner converters, pushers, elevating platforms, etc.). The individual local material flow control systems are respectively functionally assigned to just a part-quantity of the branch points and conveyor portions. Preferably, individual branch points and at least one conveyor portion respectively connected thereto boast a dedicated local material flow control system. The local material flow control systems are equipped with a memory, in which a transport section plan of the conveyor system, comprising conveyor portions and data characterizing these latter, is stored, whereby the facility is provided to carry out local transport route plannings for the conveyed items to be transported. The material flow monitor is equipped with a transmitting device, i.e. a telecommunications device accessible to all local material flow control systems, via which the local material flow control systems are informed about disturbances, i.e. abnormalities, in the conveyor system. In addition, it is essential that the individual conveyed items or groups or jointly transported conveyed items have a machine-readable information carrier, from which the respective destination of the local material flow control systems can be read. As an alternative, an indirect recognition of the transport destination can be provided, in that, for example, only an identity flag of the respective conveyed item is detected by the local material flow control system and the material flow control systems are previously supplied with a table in which the individual destinations are assigned to the identity flags. As a further alternative, it could also be envisaged in this context, instead of an identification of the conveyed items at the individual branch points by the respectively assigned material flow control systems, which identification repeatedly has to be freshly performed, to carry out a continuous material flow tracking, i.e. to pass the identity of the individual conveyed items from material flow control system to material flow control system, as it were. All that is essential is that each local material flow control system, upon the arrival of a conveyed item, can establish where the intended transport destination of this conveyed item is. A crucial feature of the present invention lies in the fact that the local material flow control systems respectively boast a route program, by which, with due regard to any existing disturbances which might have been reported by the material flow monitor, a suitable passable transport route to the respective stored destination of a conveyed item making its way into the functional area of responsibility of the respective material flow control system can be calculated. This means, therefore, that the transport route planning is carried out not in a central control system with overriding responsibility for the entire conveyor system, but at a local level. The calculation of a suitable transport route means that the respectively chosen transport route is not only physically available, i.e. for example, is not disrupted by a jam, but that this transport route is also suitable for the transportation of the respective conveyed item, i.e. is suitably sufficiently dimensioned. Within the framework of the conveyor system according to the invention, parallel transport sections having different performance features can thus readily exist.

Preferably, the characterizing data of the conveyor portions contain one or more of the following variables: transport direction, maximum transport speed, length, width, maximum permitted conveyed item weight. The knowledge of these data allows the performance features of the conveyor system to be put to optimum possible use. For this purpose, it is particularly advantageous if, on the information carriers of the conveyed items there are stored, apart from the transport destination, also one or more additional data characterizing the conveyed item, such as, for instance, maximum length, maximum width, maximum height, weight, urgency of the conveyance and/or latest time of arrival at the destination.

In order to be able to realize the machine reading of the information carriers as simply as possible, it is advisable to design these as contactlessly readable information carriers. This can advantageously be done, for example, in the form of barcode labels or tags. Data carriers could also be used, however, which are readable by a character reader (for example OCR script). Quite especially expedient, however, is the transponder method (RFID tags).

Of major importance within the scope of the invention is the secure transmission of disturbance data concerning blockages of individual conveyor portions to the individual local material flow control systems. For the operational optimization of the transport route calculation, it is expedient to communicate to the local material flow control systems, apart from of conveyor portions, for example also information concerning temporary restrictions of the transport speed of individual conveyor portions and/or about an impending overload of individual conveyor portions. Preferably, these information transmissions are effected via an air interface of the material flow monitor to the local material flow control systems, i.e. especially preferably by radio data transmission. This requires of course, in addition to an appropriate transmitting device of the material flow monitor, also respectively a corresponding receiving device at each local material flow control system.

Any investment in cabling for the construction of appropriate data lines, which could also, of course, alternatively be used to transmit the information, is unnecessary, however.

With regard to the efficiency of the conveyor system as a whole, it is advantageous if the route program of the local material flow control systems is not only capable of conducting a suitable route calculation, but can additionally also bring about a route optimization, especially with respect to the speed of the transportation or the shortness of the transport route.

A fundamental performance feature of the present invention is that any central transport route planning is dispensed with and the route planning can be carried out decentrally, distributed throughout the conveyor system, consideration nevertheless being given to the state and interests of the system as a whole, since all local material flow control systems are constantly informed about disturbances within the network of conveyor portions and branch points. This information on disturbances and other deviations (for example, temporary operating restrictions due to maintenance works) can here be distributed throughout the system at very low cost in the sense of radio transmission messages. The conveyor system according to the invention can react immediately to all disturbances without restrictions having to be tolerated elsewhere in the conveyor system as a result of the computing and data handling effort necessary for this.

The invention is explained in greater detail below with reference to an illustrative embodiment represented in the drawing.

FIGS. 1-4 show, with reference to a merely diagrammatized general plan of a conveyor system according to the invention, respectively different scenarios.

The conveyor system of FIGS. 1-4 is made up of a multiplicity of conveyor sub-sections, which are referred to as section 1.1-1.3, section 2.1-2.2 and section 3.1-3.3. Each section 1.1-3.3 is formed from one or two transport sections 1-14, which can also be referred to as conveyor modules. The two conveyor strands formed from the conveyor portions 1-5 and 6-10 lead respectively from a delivery point for conveyed items (not referred to in greater detail) to respectively one of the two possible transport destinations A and B. The conveyor strand formed from the conveyor portions 6-10 has two branch points, which are denoted by the reference numerals 30, 31. At these branch points 30, 31, the conveyed item, which in the present case rests on the conveyor portion 6 and is denoted by 20, can optionally be directed via section 2.1 or section 2.2 to the destination A of the other conveyor strand comprising the conveyor portions 1-5. The branch points 30, 31 are therefore, for example, designed as switches, the details of which cannot however be derived from the representation. The actuation of the switches is conducted by means of the two local material flow control systems LFC1 and LFC2, represented symbolically as circles. The two local material flow control systems boast a route program for the calculation of transport routes, a memory containing a transport section plan of the conveyor system inclusive of characterizing data of conveyor portions, at least with respect to that part of the conveyor system which is situated downstream from the conveying engineering aspect. In addition, the local material flow control systems are equipped with a receiver for receiving state or disturbance messages about individual components of the conveyor system. A material flow monitor MFM is symbolically represented as a hexagon and is connected to a multiplicity of sensors (not represented) for monitoring the working of the individual system components.

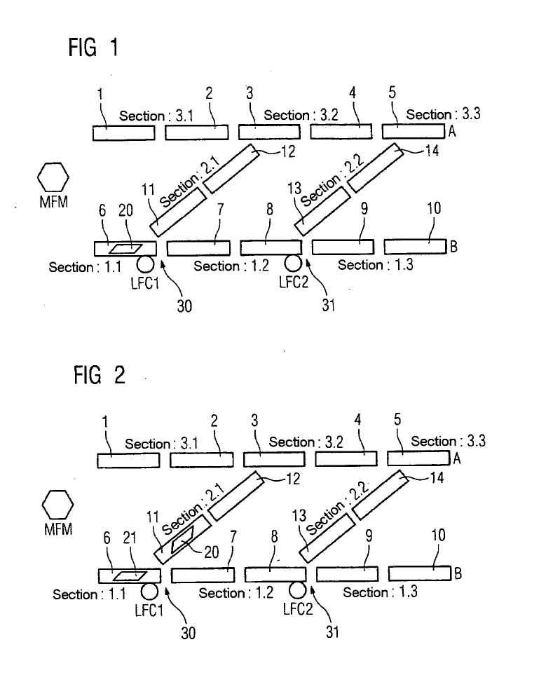

If now a conveyed item 20 is delivered, for example, to the conveyor portion 6 and approaches the branch point 30, a machine-readable information carrier of the conveyed item 20, on which the desired destination is stored, can be read by an appropriate reader of the local material flow control system LFC1. Based on the transport section plan of the conveyor system and the knowledge of possible disturbances within the conveyor system, the local material flow control system LFC1 can determine the potential routes for the transport of the conveyed item 20 to the destination A which is sought in the present case. Both the path via sections 2.1, 3.2 and 3.3. and the path via sections 1.2, 2.2. 3.3 can be considered. Since in the present case it is assumed that all said sections have an equally high throughput and also represent equally long path distances, the local material flow control system LFC1 simply selects the first of the two options which is represented in FIG. 2 and in which the conveyed item 20 has already reached the conveyor portion 11, while a second conveyed item 21, intended, for example, for the same destination A, has already been delivered onto the conveyor portion 6 and can take the same path.

If, however, under the premises of a changed scenario, the material flow monitor MFM were to be informed about the existence of a disturbance via a sensor system, which, for example, can be a light barrier or else can be integrated into the drive of a conveyor portion 1-14, the transmitting device 40, symbolized in the form of a jagged arrow, makes an appropriate communication to all local material flow control systems LFC1-LFC2 of the conveyor system, as can be seen from FIG. 3. In the present case, it has been assumed that section 2.2 is impassable due to a disturbance (material jam or fault in the drive of the conveyor portion 13 or 14), as indicated by the illustrated cross. In this case, the local material flow control system LFC1 has only one of the two fundamentally possible transport route alternatives actually available to it. Even though the conveyor path via section 2.2, owing to the higher possible transport speed of 1.5 m/s compared to the transport speed of only 0.5 m/s in section 2.1, would otherwise be more favorable per se, the only free path via section 2.1 is therefore chosen.

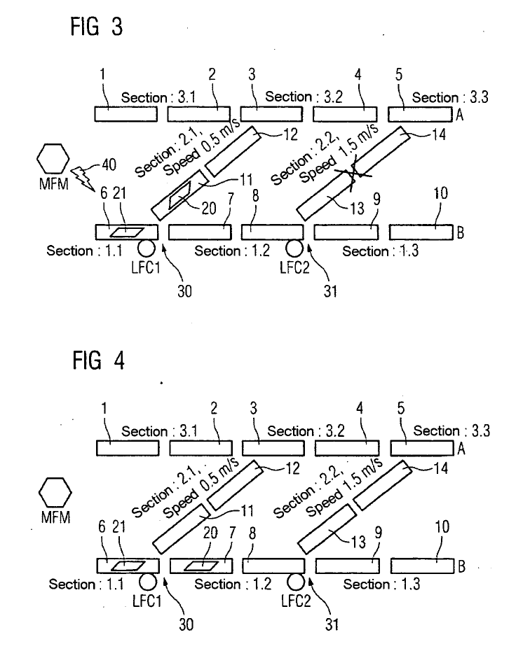

If, on the other hand, there is no disturbance present in the conveyor system, as is the case in the situation represented in FIG. 4, then the local material flow control system LFC1 chooses, for the reaching of the transport destination A by the two conveyed items 20, 21, the path via sections 1.2, 2.2 and 3.3, especially as this path is no longer than the alternative path, since it is significantly faster. When the conveyed items 20, 21 make their way into the area of responsibility of the local material flow control system LFC2 in the region of the branch point 31, there too the transport destination is once again enquired about and a transport route calculation conducted, which in the present case contains, however, just a single option via section 2.2 to the destination A.

The conveyor system according to the invention has a very high redundancy. A large conveyor system therefore remains operative even if one or more local material flow control systems were to fail. In this case, the other local material flow control systems would in fact be capable of automatically having alternative transport routes calculated and executed. Compared to a conveyor system having a central material flow control, the decentralized material flow control system according to the invention guarantees extremely short system response times. This decentralized approach allows, in particular, the advantageous use of new technologies such as, for instance, the use of RFID tags, which are more demanding in terms of data volume and processing capacity. Optimizations and modifications of the conveyor system can be extremely easily incorporated into the system control by an appropriate updating of the transport section plan (material handling system map) with new characteristics.

1.-10. (canceled)

11. An airport baggage conveyor system, for transporting conveyed items to individual destinations on transport routes having a plurality of conveyor portions and branch points, comprising:
an electronic control system that determines a transport route, for each conveyed item, leading to the respective destination and the branch points are respectively controlled in accordance with the transport route, the conveyed items respectively having an information carrier that is machine-readable by the control system; and
a material flow monitor that comprises
a sensor system for registering disturbances of the conveyor portions and branch points,
a plurality of local material flow control systems that are respectively functionally assigned respectively only to one branch point and to at least one conveyor portion connected thereto, where the local material flow control systems comprise a memory, where a transport section plan of the conveyor system, comprise conveyor portions and data characterizing transport section plan is stored,
a transmitting device via which the local material flow control systems are informed about disturbances in the conveyor system, in that the respective destination of the conveyed item is stored on the information carriers, and
a route program, by which, with due regard to any disturbances which might possibly exist, a suitable transport route to the respective stored destination of a conveyed item making its way into the functional area of responsibility of the respective material flow control system is calculated.

12. The conveyor system as claimed in claim 11, wherein the characterizing data of the conveyor portions contain one or more of the following variables: transport direction, maximum transport speed, length, width, maximum permitted conveyed item weight.

13. The conveyor system as claimed in claim 12, wherein on the information carriers of the conveyed items there are stored one or more additional data characterizing the conveyed item.

14. The conveyor system as claimed in claim 13, wherein the additional data characterizing the conveyed item is selected from the group consisting of: maximum length, maximum width, maximum height, weight, urgency of the conveyance, latest time of arrival at the destination and combinations thereof.

15. The conveyor system as claimed in claim 14, wherein the information carrier is contactlessly readable.

16. The conveyor system as claimed in claim 15, wherein the information carrier has a barcode marking.

17. The conveyor system as claimed in claim 15, wherein the information carrier is configured as a RFID tag.

18. The conveyor system as claimed in claim 17, wherein the transmitted disturbance data, apart from of individual conveyor portions, also contain transport speed restrictions or information on an impending overload of individual conveyor.

19. The conveyor system as claimed in claim 18, wherein the transmitted disturbance data, apart from of individual conveyor portions, also contain transport speed restrictions and information on an impending overload of individual conveyor.

20. The conveyor system as claimed in claim 19, wherein the transmitting device of the material flow monitor boasts an air interface to the local material flow control systems.

21. The conveyor system as claimed in claim 19, wherein the transmitting device of the material flow monitor distributes the disturbance data via a data line.

22. The conveyor system as claimed in claim 21, wherein the local material flow control system respectively contains a route program which conducts a route optimization with respect to the rapidity or shortness of the transport route.
